(19) United States
(12) Patent Application Publication
(10) Pub. No.: US 2021/0326754 A1
(43) Pub. Date: Oct. 21, 2021

(54) STORAGE MEDIUM, LEARNING METHOD, AND INFORMATION PROCESSING APPARATUS

(71) Applicant: FUJITSU LIMITED, Kawasaki-shi (JP)

(72) Inventors: Kanata SUZUKI, Kawasaki (JP); Yasuto YOKOTA, Kawasaki (JP)

(73) Assignee: FUJITSU LIMITED, Kawasaki-shi (JP)

(21) Appl. No.: 17/213,221

(22) Filed: Mar. 26, 2021

(30) Foreign Application Priority Data
Apr. 16, 2020 (JP) 2020-073729

(51) Int. Cl. G06N 20/00; G06K 9/62

(52) U.S. Cl. CPC G06N 20/00; G06K 9/6256; G06K 9/6215

(57) ABSTRACT

A non-transitory computer-readable storage medium storing a program that causes a computer to execute a process, the process includes identifying, among combinations of any two pieces of image data included in a plurality of pieces of image data that satisfies a first condition, similarity between two pieces of image data in a combination in which one image data satisfies a second condition in addition to the first condition; identifying, based on the calculated similarity between the two pieces of image data, a score that becomes greater as the similarity increases; and performing, by using training data based on another image data in the combination and the score, machine learning.

### CROSS-REFERENCE TO RELATED APPLICATION

This application is based upon and claims the benefit of priority of the prior Japanese Patent Application No. 2020-073729, filed on Apr. 16, 2020, the entire contents of which are incorporated herein by reference.

### FIELD

The embodiments discussed herein are related to a storage medium, a learning method, and an information processing apparatus.

### BACKGROUND

With development of robot functions, use of robots is expected as an alternative to manual work. To operate a robot in the same way as manual work, the robot needs to be operated by a skilled person. Therefore, to operate a robot automatically, the robot is made to learn an operation trajectory of manual work by machine learning including deep learning.

For example, a model is generated by executing machine learning by using a large amount of training data in which an image is associated with a teacher label indicating a desired operation content, and at the time of prediction after the learning is completed, an image is input to the model to predict an operation content. In addition, in object detection by machine learning, a model is generated by executing machine learning by using training data in which each image is associated with a desired output and an object position, and at the time of prediction, an object position is also predicted.

However, it may be difficult to collect a large amount of training data to which teacher labels are added (hereinafter, may be referred to as teaching data) in advance. Thus, in recent years, sequential learning (hereinafter, may be referred to as teaching-less learning) is used in which a machine learning model predicts operation and machine learning is sequentially executed while obtaining feedback as to whether or not a result of the prediction is successful. Taking a picking robot as an example, an object to be gripped is predicted from an image showing a plurality of objects by using a machine learning model, and then picking operation is actually performed by an actual machine according to the prediction, and success or failure of gripping is evaluated according to the actual operation. In this way, training data in which an image and success or failure of gripping are associated (hereinafter, may be referred to as a trial sample) is generated and accumulated, and when a predetermined number or more of trial samples are accumulated, machine learning is executed by using the accumulated trial samples. As related art, Lerrel Pinto, Abhinav Gupta, “Supersizing Self-supervision: Learning to Grasp from 50K Tries and 700 Robot Hour”, Sep. 23, 2015, arXiv: 1509.06825v1, and the like are disclosed.

### SUMMARY

According to an aspect of the embodiments, A non-transitory computer-readable storage medium storing a program that causes a computer to execute a process, the process includes identifying, among combinations of any two pieces of image data included in a plurality of pieces of image data that satisfies a first condition, similarity between two pieces of image data in a combination in which one image data satisfies a second condition in addition to the first condition; identifying, based on the calculated similarity between the two pieces of image data, a score that becomes greater as the similarity increases; and performing, by using training data based on another image data in the combination and the score, machine learning.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram explaining an information processing apparatus according to a first embodiment;

FIG. 2 is a diagram explaining the information processing apparatus according to the first embodiment;

FIG. 3 is a functional block diagram illustrating a functional configuration of the information processing apparatus according to the first embodiment;

FIG. 4 is a diagram explaining training data for evaluation;

FIG. 5 is a diagram explaining ideal grip data;

FIGS. 6A and 6B are diagrams explaining data that does not correspond to the ideal grip data;

FIG. 7 is a diagram explaining image data of a trial sample;

FIG. 8 is a diagram explaining machine learning of an evaluation model;

FIG. 9 is a diagram explaining details of the machine learning of the evaluation model;

FIG. 10 is a diagram explaining a series of flows of machine learning of a detection model;

FIG. 11 is a diagram explaining the series of the flows of the machine learning of the detection model;

FIG. 12 is a diagram explaining the series of the flows of the machine learning of the detection model;

FIG. 13 is a diagram explaining the series of the flows of the machine learning of the detection model;

FIG. 14 is a diagram explaining calculation of a grip score;

FIG. 15 is a diagram explaining generation of the trial sample;

FIG. 16 is a diagram explaining the machine learning of the detection model;

FIG. 17 is a diagram explaining parameter update of the detection model;

FIG. 18 is a flowchart illustrating a flow of learning processing of the evaluation model;

FIG. 19 is a flowchart illustrating a flow of generation processing of the trial sample and learning processing of the detection model;

FIG. 20 is a flowchart illustrating a flow of a series of processing including pre-learning; and

FIG. 21 is a diagram explaining a hardware configuration example.

### DESCRIPTION OF EMBODIMENTS

However, in the above sequential learning, since it is difficult to include a degree of success in training data which is a trial sample, machine learning is not stable, and there is a possibility of fall into a local solution, and accuracy of machine learning may be lowered.

For example, success or failure of gripping when picking operation is performed by an actual machine may be determined only by whether the gripping is successful or unsuccessful. Therefore, even in a case where it is desirable that gripping a fragile portion, such as in a precision instrument, is learned as a failure pattern, when the gripping is successful, it is learned as a success pattern.

Note that, although a parameter design considering all gripping patterns may be considered, it is not realistic because there are innumerable gripping patterns depending on the shape of an object. In addition, although it is possible to use a machine learning model that evaluates a degree of success, the cost of separately preparing training data for learning the machine learning model in advance is high, and it does not match an original purpose of sequential learning.

In view of the above, it is desirable to improve accuracy of machine learning.

Hereinafter, embodiments of a learning program, a learning method, and an information processing apparatus disclosed in the present application will be described in detail with reference to the drawings. Note that the present disclosure is not limited to the embodiments. In addition, the embodiments may be appropriately combined within a range without inconsistency.

### First Embodiment

[Description of Information Processing Apparatus]

An information processing apparatus 10 according to a first embodiment is an example of a computer device that predicts a gripping position (gripping object) of a picking robot (hereinafter, may be referred to as an “actual machine”), and detects the gripping position from an image showing a plurality of objects as gripping objects. In the information processing apparatus 10, a detection model using machine learning predicts an output, and machine learning of the detection model is sequentially executed while obtaining feedback as to whether or not a result of the prediction is appropriate.

For example, the information processing apparatus 10 inputs an image to the detection model, predicts a gripping position, and actually performs picking operation by the picking robot according to the prediction. Then, the information processing apparatus 10 evaluates success or failure of gripping according to the actual operation, and generates a trial sample in which the image, the success or failure of gripping, and a teacher label (successful gripping position) are associated with each other.

In this way, the information processing apparatus 10 generates teaching data from an evaluation result of the actual operation using the actual machine, and then executes machine learning of the detection model. At this time, in evaluation of success or failure of gripping, the information processing apparatus 10 improves accuracy of machine learning of the detection model not only by determining success or failure but also by calculating a grip score indicating a degree of success.

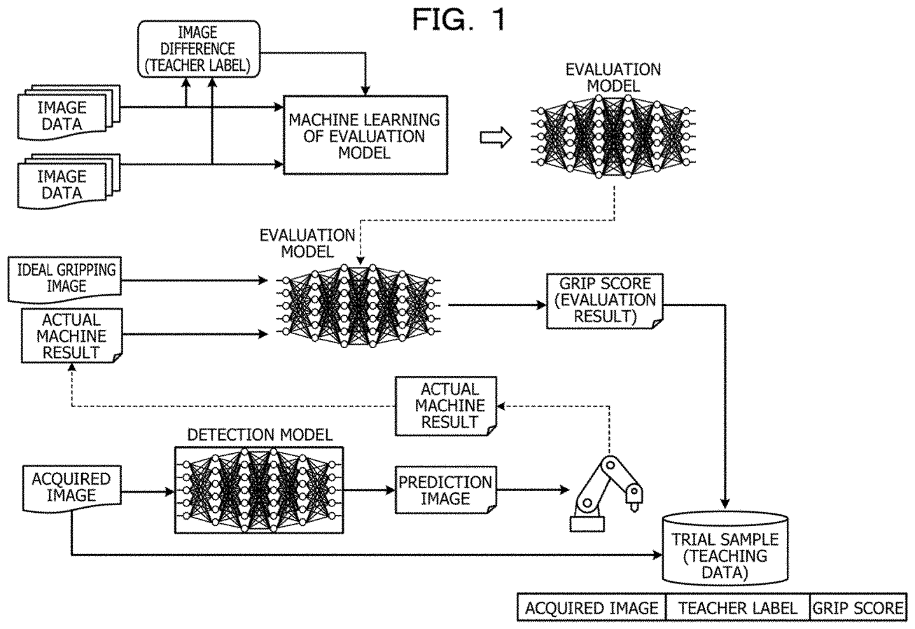

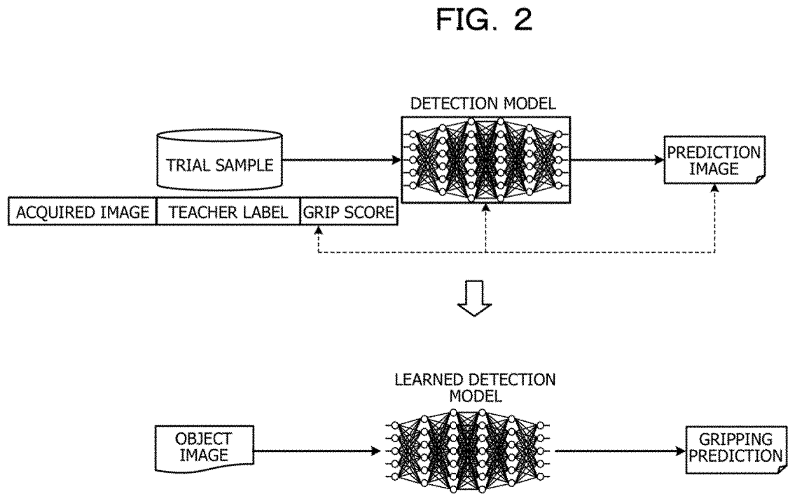

FIGS. 1 and 2 are diagrams explaining the information processing apparatus 10 according to the first embodiment. As illustrated in FIG. 1, the information processing apparatus 10 executes, by using an image pair, machine learning of an evaluation model that evaluates similarity between images. For example, the information processing apparatus 10 selects two images from a plurality of image groups and calculates similarity between the images. Then, the information processing apparatus 10 executes machine learning of the evaluation model by using the two images as explanatory variables and a teacher label based on the similarity as an objective function.

Subsequently, the information processing apparatus 10 inputs an acquired image showing an object to a detection model before learning, and acquires a prediction image for predicting a gripping object. Thereafter, the information processing apparatus 10 executes, by using an actual machine, gripping of the gripping object specified by the prediction image, and generates an actual machine result which is an image showing an actual gripping result. Then, the information processing apparatus 10 inputs an ideal gripping image showing an ideal gripping result and the actual machine result to the learned evaluation model, and calculates a grip score indicating a degree of success by using an output by the evaluation model. Thereafter, the information processing apparatus 10 generates a trial sample in which the acquired image, the teacher label, and the grip score are associated with each other.

Thereafter, when a prescribed number or more of trial samples are generated, machine learning of the detection model is executed. For example, as illustrated in FIG. 2, when the information processing apparatus 10 inputs an acquired image of each trial sample as an explanatory variable to the detection model, and executes machine learning of the detection model based on an error between a prediction result, which is an output result of the detection model, and the teacher label, the information processing apparatus 10 executes the machine learning while performing feedback adjustment according to the grip score.

In this way, when machine learning of the detection model is completed, the information processing apparatus 10 inputs an object image showing an object to the learned detection model, and executes gripping detection (gripping prediction) for detecting a gripping position of the picking robot by an output of the detection model.

[Functional Configuration]

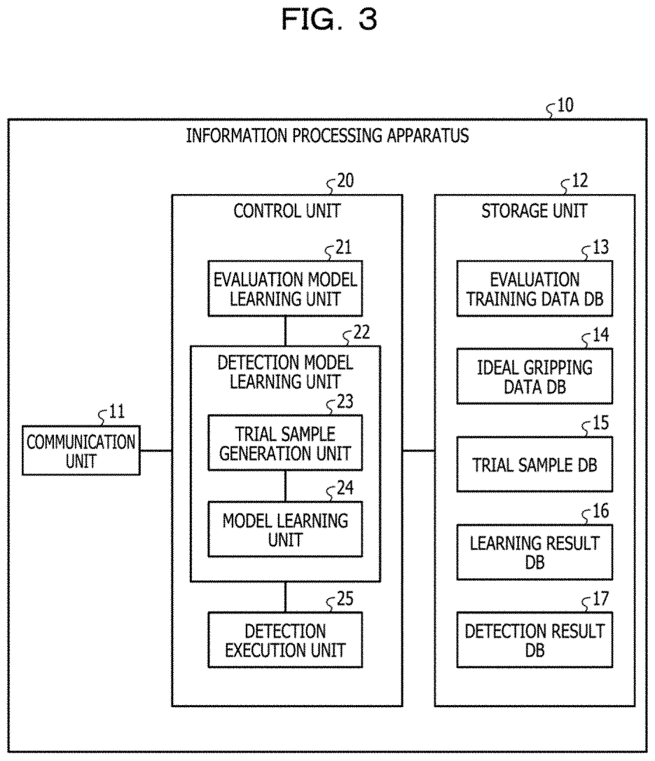

FIG. 3 is a functional block diagram illustrating a functional configuration of the information processing apparatus 10 according to the first embodiment. As illustrated in FIG. 3, the information processing apparatus 10 includes a communication unit 11, a storage unit 12, and a control unit 20.

The communication unit 11 is a processing unit that controls communication with another device, and is implemented by a communication interface, for example. For example, the communication unit 11 transmits an operation instruction to the picking robot which is the actual machine, and acquires an operation result from the picking robot. Note that the operation result may be image data, or a command result or the like capable of generating image data.

The storage unit 12 is a processing unit that stores various types of data, programs executed by the control unit 20, and the like, and is implemented by a memory or a hard disk, for example. For example, the storage unit 12 stores an evaluation training data database (DB) 13, an ideal grip data DB 14, a trial sample DB 15, a learning result DB 16, and a detection result DB 17.

The evaluation training data DB 13 stores a plurality of pieces of training data used for machine learning of the evaluation model. For example, each piece of training data stored in the evaluation training data DB 13 includes a pair of two pieces of image data. Here, generation of training data when the training data is input to the evaluation model will be described. Note that the generation of training data may be executed by, for example, the control unit 20 or an evaluation model learning unit 21, which will be described later, or may be executed in advance by another device, but here, an example will be described in which the generation of training data is executed by the evaluation model learning unit 21.

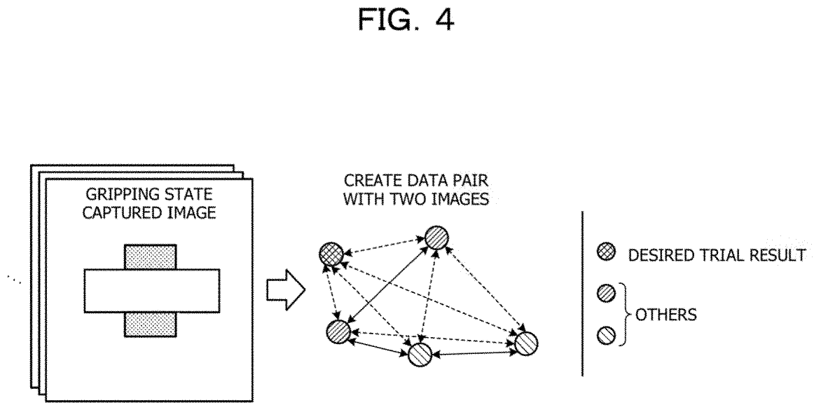

FIG. 4 is a diagram explaining training data for evaluation. As illustrated in FIG. 4, the evaluation model learning unit 21 acquires a plurality of pieces of gripping state captured image data which are raw image data with no labels set and no special preprocessing applied and which are images of gripping states captured in advance, and generates a data set. Here, the data set includes ideal grip data which is an image of a desired gripping state. Then, the evaluation model learning unit 21 generates, as one set of training data, a combination of two pieces of image data (x₁, x₂) by combining each piece of image data in the data set.

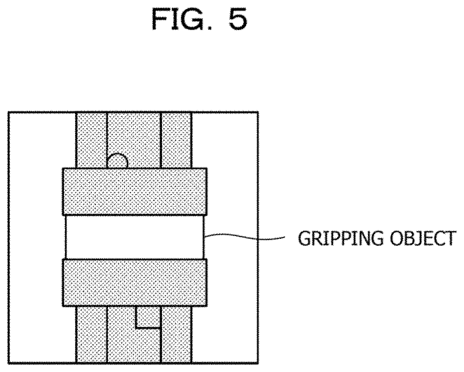

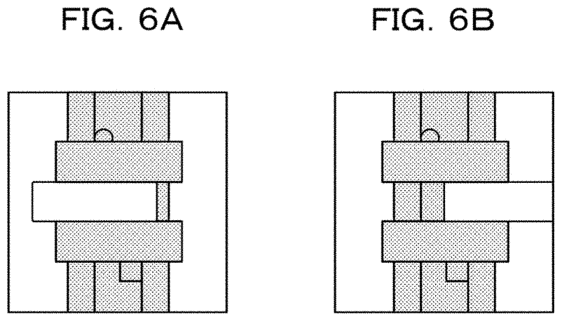

The ideal grip data DB 14 stores ideal grip data which is an image of a desired gripping state. FIG. 5 is a diagram explaining the ideal grip data, and FIGS. 6A and 6B are diagrams explaining data that does not correspond to the ideal grip data. As illustrated in FIG. 5, the ideal grip data is an image in which an electronic component or the like as a gripping object is gripped without shifting relative to the upper and lower gripping portions. On the other hand, as illustrated in FIGS. 6A and 6B, an image in which a gripping object is gripped in a state where the gripping object is shifted relative to upper and lower gripping portions is excluded from the ideal grip data, although the gripping object may be gripped.

Note that the ideal grip data is captured and stored in advance by an administrator or the like. In addition, an example in which the state of FIG. 5 is used as the ideal grip data has been described here, but the present embodiment is not limited to this example. For example, in consideration of nature of the electronic component as the gripping object, the state of FIG. 6A or 6B may be used as the ideal grip data in order not to grip a fragile portion.

The trial sample DB 15 stores a trial sample which is an example of training data used for machine learning of the detection model. For example, the trial sample DB 15 stores a trial sample in which image data, a teacher label, and a grip score are associated with each other. The trial sample stored here is used for supervised learning of the detection model.

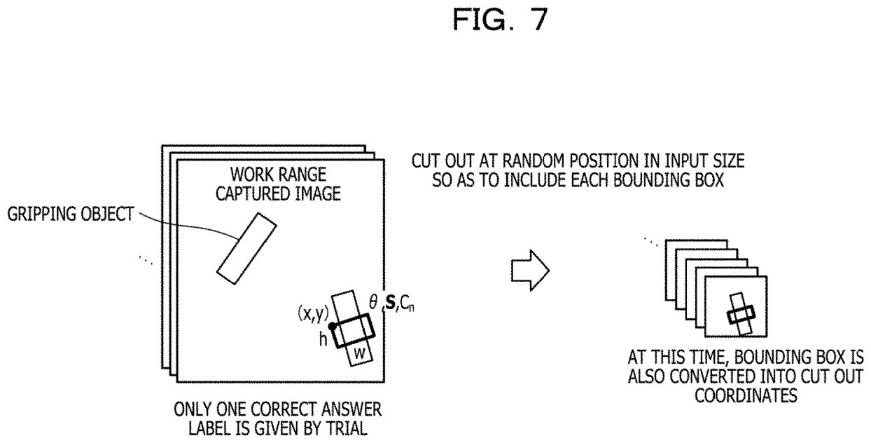

FIG. 7 is a diagram explaining image data of the trial sample. As illustrated in FIG. 7, the image data of the trial sample is a work range captured image that is obtained by capturing a work range of the picking robot and that includes bounding boxes indicating positions of a plurality of gripping objects. When the image data of the trial sample is input to the detection model, the image data is input after being cut out at a random position in an input size of the detection model so as to include each bounding box. At this time, the bounding box is also converted into cut out coordinates. Note that, for each piece of image data generated from one work range captured image, only one correct answer label is given in the image data because the correct label is obtained by trial of the picking robot.

Here, the bounding box indicates an object gripping position in the work range captured image, and has information of “x, y, h, w, θ, S, and Cₙ”. x and y indicate detection positions, h and w indicate sizes, θ indicates a rotation angle, S indicates a grip score, and Cₙ indicates a probability of belonging to a class n. The grip score indicated by S is set by a trial sample generation unit 23 to be described later. Note that the image data of the trial sample is input to the detection model after general data expansion such as slide, color conversion, and scale conversion are executed.

The learning result DB 16 stores a machine learning result of each model. For example, the learning result DB 16 stores a machine learning result of the evaluation model, a machine learning result of the detection model, and the like. Here, each machine learning result includes each optimized parameter of a neural network or the like.

The detection result DB 17 stores a detection result using the learned detection model. For example, the detection result DB 17 stores an image which is a detection object and a gripping object of the picking robot, which is an output result of the detection model, in association with each other.

The control unit 20 is a processing unit that controls the entire information processing apparatus 10 and is implemented by, for example, a processor. The control unit 20 includes the evaluation model learning unit 21, a detection model learning unit 22, and a detection execution unit 25. Note that the evaluation model learning unit 21, the detection model learning unit 22, and the detection execution unit 25 may be implemented as an electronic circuit such as a processor, or may be implemented as a process executed by the processor.

The evaluation model learning unit 21 is a processing unit that generates training data stored in the evaluation training data DB 13 and executes machine learning of the evaluation model using the training data stored in the evaluation training data DB 13.

(Generation of Training Data)

First, generation of training data will be described. For example, the evaluation model learning unit 21 inputs image data to the detection model and acquires a prediction of a gripping position. Then, the evaluation model learning unit 21 executes picking operation using the actual machine for the predicted gripping position, and acquires image data of the actual picking operation. The evaluation model learning unit 21 stores the image data of the actual picking operation collected in this way in the evaluation training data DB 13, and generates the training data for the evaluation model. Note that the training data may also be created in advance by an administrator or the like and stored in the evaluation training data DB 13.

(Machine Learning of Evaluation Model)

Next, machine learning of the evaluation model will be described. For example, the evaluation model learning unit 21 generates the evaluation model by executing, using training data stored in the evaluation training data DB 13, metric learning by using a pair of two pieces of image data as explanatory variables and a teacher label based on an image difference which is a difference between the pieces of image data as an objective variable. Then, when machine learning is completed, the evaluation model learning unit 21 stores a learning result or the learned evaluation model in the learning result DB 16. Note that the timing for ending machine learning may be optionally set, for example, when machine learning using a predetermined number of training data is executed or when a restoration error is equal to or smaller than a threshold.

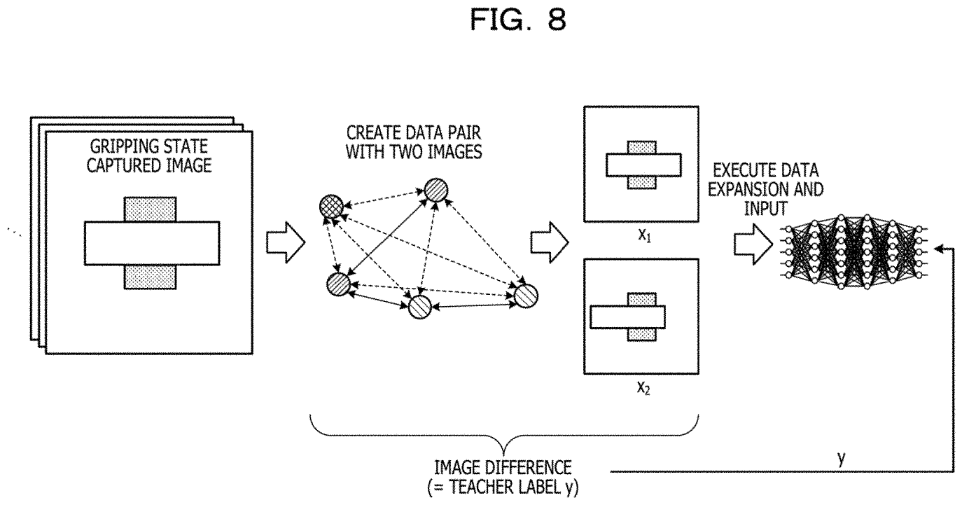

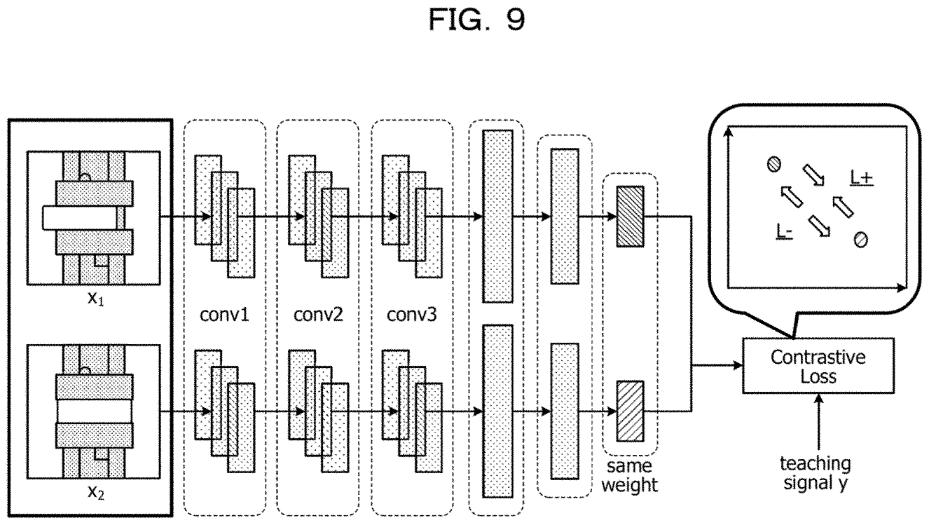

FIG. 8 is a diagram explaining machine learning of the evaluation model, and FIG. 9 is a diagram explaining details of the machine learning of the evaluation model. As illustrated in FIG. 8, the evaluation model learning unit 21 reads two pieces of image data (x₁, x₂) from the evaluation training data DB 13, and calculates similarity between the two pieces of image data. Subsequently, the evaluation model learning unit 21 sets a teacher label y (for example, 1.0) indicating that the two pieces of image data (x₁, x₂) match when the similarity is equal to or greater than the threshold, and sets a teacher label y (for example, 0.0) indicating that the two pieces of image data (x₁, x₂) do not match when the similarity is less than the threshold. Thereafter, the evaluation model learning unit 21 executes various types of data expansion on the two pieces of image data, and inputs the two pieces of image data to the evaluation model.

Subsequently, as illustrated in FIG. 9, the evaluation model learning unit 21 executes metric learning of the evaluation model by supervised learning using the two pieces of image data as explanatory variables and the teacher label as an objective variable. In the first embodiment, Siamese networks (SNs) are used as the evaluation model. The SNs use a set of pieces of image data as an input and two-dimensional feature vectors as an output. In addition, in the SNs, the two pieces of image data are input to different networks, but each network has the same configuration and shares parameters such as weight. Furthermore, in the SNs, two feature vectors output from the two pieces of image data are compared, and a distance between the feature vectors is calculated using a Euclidean distance or the like.

Using this feature, the evaluation model learning unit 21 inputs two pieces of image data to the SNs, acquires a feature vector corresponding to each piece of image data, and calculates a distance between the feature vectors. Then, the evaluation model learning unit 21 optimizes each parameter of the SNs by using a Contrastive Loss function indicated in Equation (1) on the basis of an error (contrastive loss) based on the distance so that a distance between the same samples is close and a distance between different samples is far.

[Mathematical Formula 1]

L=Σ½((1−y)*L₊+y*L₋) Equation (1)

In the above example, in a case where the teacher label y (for example, 1.0) indicating that the two pieces of image data are similar is set between the two pieces of image data, the evaluation model learning unit 21 determines that the two pieces of image data are the same samples, and executes learning so that “L₊=similar loss” indicated in Equation (2) becomes small. On the other hand, in a case where the teacher label y (for example, 0.0) indicating that the two pieces of image data are not similar is set between the two pieces of image data, the evaluation model learning unit 21 determines that the two pieces of image data are different samples, and executes learning so that “L₋=dissimilar loss” indicated in Equation (2) becomes large.

$$\begin{matrix}[ Mathematical Formula 2 ] & \\ {L}_{+} = {D ( {x}_{1} , {x}_{2} )}^{2} & Equation ( 2 ) \\ [ Mathematical Formula 3 & \\ {L}_{-} = \{ \begin{matrix}( margin - {D ( {x}_{1} , {x}_{2} )}^{2} ) , & if {L}_{-} \geq 0 , \\ 0 , & otherwise\end{matrix} & Equation ( 3 )\end{matrix}$$

In this way, the evaluation model learning unit 21 executes metric learning using the training data stored in the evaluation training data DB 13 to generate an evaluation model.

Returning to FIG. 3, the detection model learning unit 22 is a processing unit that includes the trial sample generation unit 23 and a model learning unit 24, and executes generation of the detection model. The trial sample generation unit 23 generates training data (trial sample) used for machine learning of the detection model by using the learned evaluation model, and stores the trial sample in the trial sample DB 15. The model learning unit 24 is a processing unit that executes machine learning of the detection model by using the trial sample.

(Machine Learning of Detection Model)

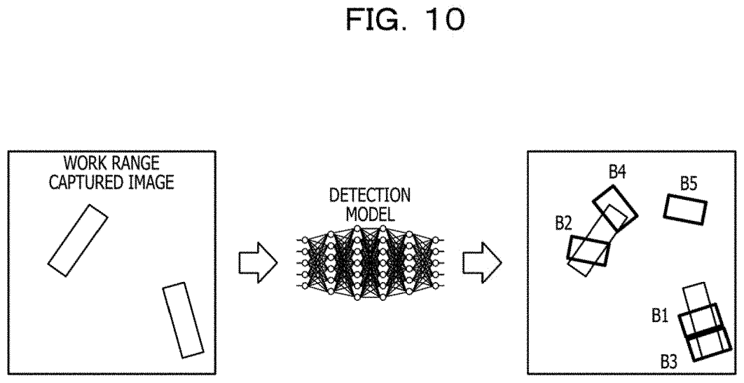

First, a series of flows of machine learning of the detection model will be described. FIGS. 10 to 13 are diagrams explaining the series of the flows of the machine learning of the detection model. As illustrated in FIG. 10, the trial sample generation unit 23 cuts out a work range captured image including at least one gripping object into image data of a fixed size and inputs the image data to the detection model by a method similar to that described with reference to FIG. 7. Then, the trial sample generation unit 23 selects, as an estimation result, an output having the k-th highest prediction probability among outputs of the detection model in response to the inputs of pieces of image data. Note that k may be optionally set. Here, it is assumed that B1 is estimated as a gripping object.

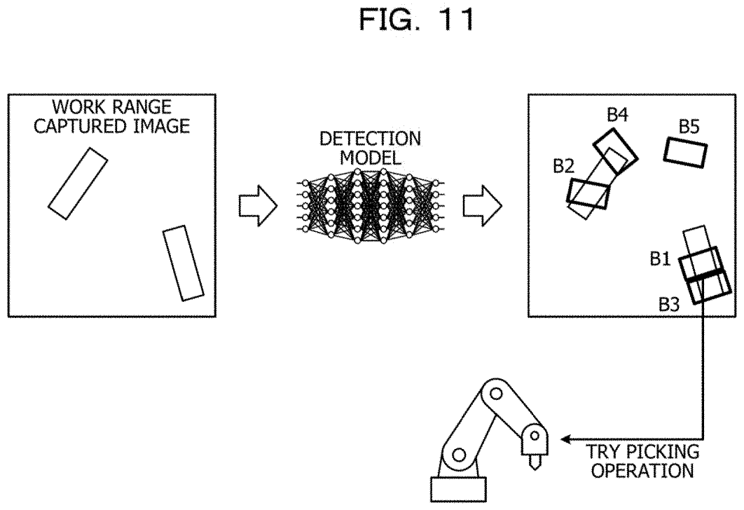

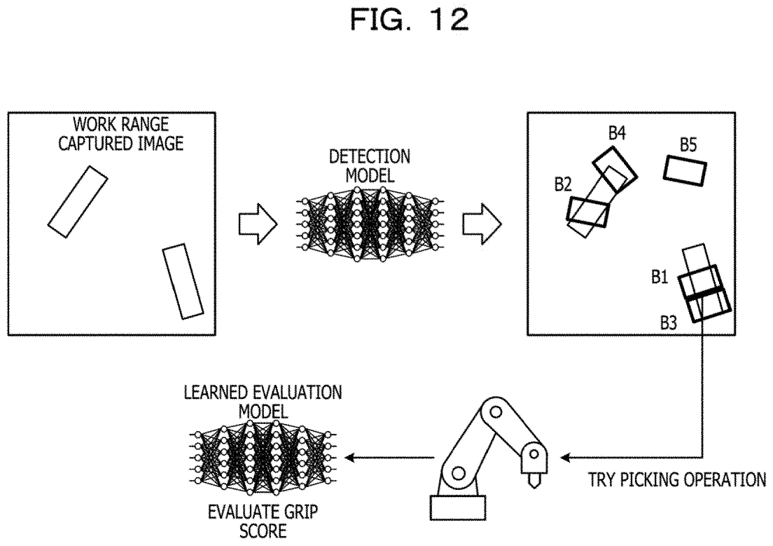

Subsequently, as illustrated in FIG. 11, the trial sample generation unit 23 operates the picking robot, which is the actual machine, so as to grip B1 estimated as a gripping position, and acquires image data of an operation result (hereinafter, may be referred to as “actual machine gripping result”). Then, as illustrated in FIG. 12, the trial sample generation unit 23 inputs the actual machine gripping result to the learned evaluation model. Here, the learned evaluation model evaluates the operation of the actual machine.

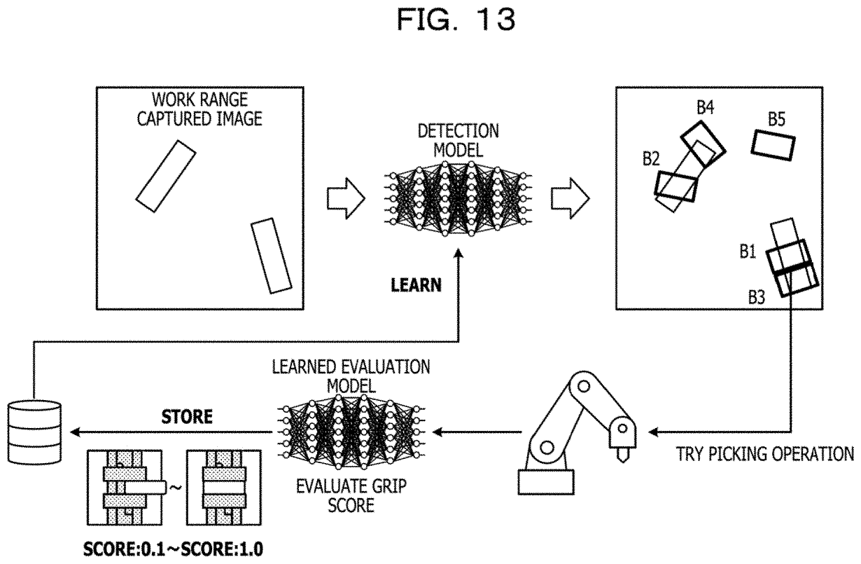

Thereafter, as illustrated in FIG. 13, the trial sample generation unit 23 calculates a grip score indicating a difference from an ideal gripping state by using an output of the learned evaluation model in response to the input of the actual machine gripping result. Here, for the grip score, a grip score “1.0” is calculated when similarity is highest, and a grip score “0.1” is calculated when similarity is lowest.

Then, the model learning unit 24 generates a trial sample by associating the work range captured image with the grip score, and executes machine learning of the detection model by using the trial sample. At this time, among bounding boxes in the work range captured image, a teacher label showing a correct answer may be set for a bounding box that is actually gripped, and a teacher label showing an incorrect answer may be set for other bounding boxes.

(Calculation of Grip Score)

Next, calculation of a grip score will be described. The trial sample generation unit 23 acquires a learning result of the evaluation model from the learning result DB 16, and constructs the learned evaluation model. Then, the trial sample generation unit 23 calculates a distance between an optimum gripping position and image data of an operation result by using the learned evaluation model, and sets the distance as a grip score.

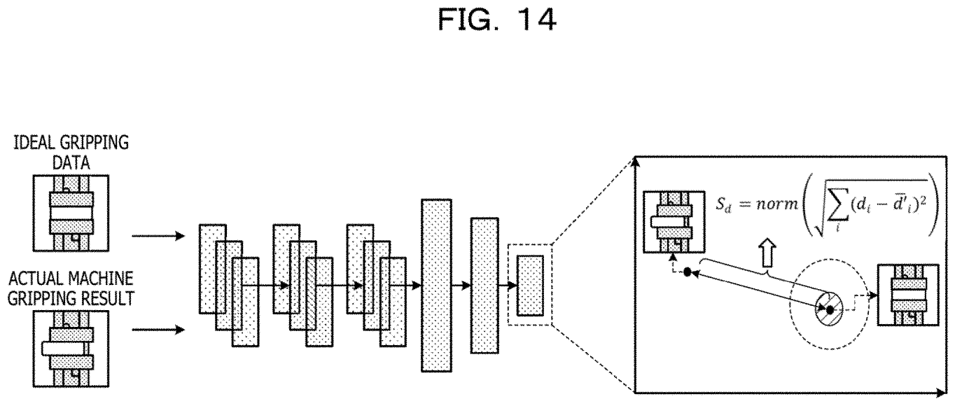

FIG. 14 is a diagram explaining calculation of a grip score. As illustrated in FIG. 14, the trial sample generation unit 23 inputs, to the learned evaluation model, ideal grip data stored in the ideal grip data DB 14 and image data of an operation result acquired by operation of the actual machine (actual machine gripping result). Then, the trial sample generation unit 23 acquires, as outputs of the learned evaluation model, a feature vector corresponding to the ideal gripping data and a feature vector corresponding to the actual machine gripping result, and calculates a Euclidean distance S_{d} between these feature vectors. Note that a neural network applied to the evaluation model is designed to output feature vectors in a range of [−1.0, 1.0].

Then, the trial sample generation unit 23 sets a grip score according to the Euclidean distance to a work range captured image used for generating the image data of the operation result or each bounding box in which a teacher label showing a correct answer or a teacher label showing an incorrect answer is set in the work range captured image, and generates a trial sample. In this way, the trial sample generation unit 23 generates the trial sample and stores the trial sample in the trial sample DB 15.

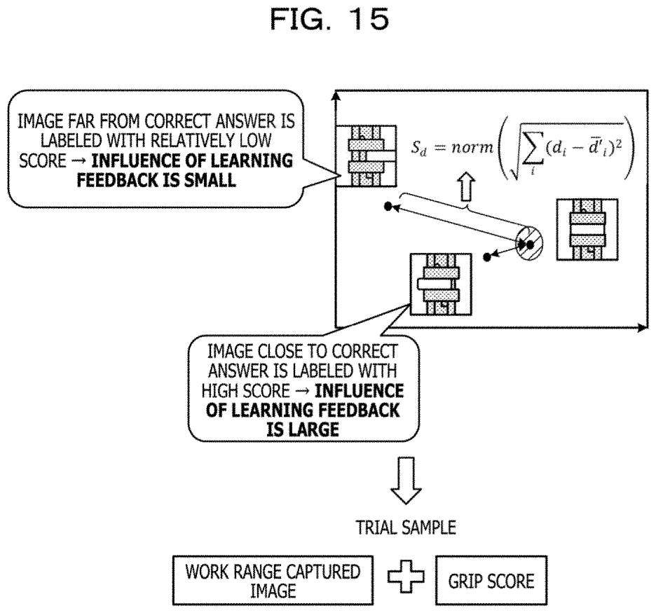

FIG. 15 is a diagram explaining generation of a trial sample. As illustrated in FIG. 15, the trial sample generation unit 23 adds a relatively low grip score to an operation result far from a correct answer (ideal gripping data), thereby reducing an influence of feedback at the time of machine learning of the detection model. On the other hand, the trial sample generation unit 23 adds a relatively high grip score to an operation result close to the correct answer (ideal gripping data), thereby increasing the influence of the feedback at the time of machine learning of the detection model.

For example, the trial sample generation unit 23 may add a grip score to an operation result by dividing the grip score into 10 stages in a range from “1.0” to “−1.0” and associating a range of a Euclidean distance with each stage. Note that, as a feature vector of the ideal grip data, an average value of a plurality of pieces of ideal grip data may be used. In addition, since a distance between two points is [0.0, route 2], a reciprocal with a constant added so as to increase the grip score as the distance decreases is taken. In this way, by increasing a grip score of a trial sample close to a desired sample (ideal gripping), it is possible to increase feedback at the time of training of the trial sample closer to success.

(Learning of Detection Model)

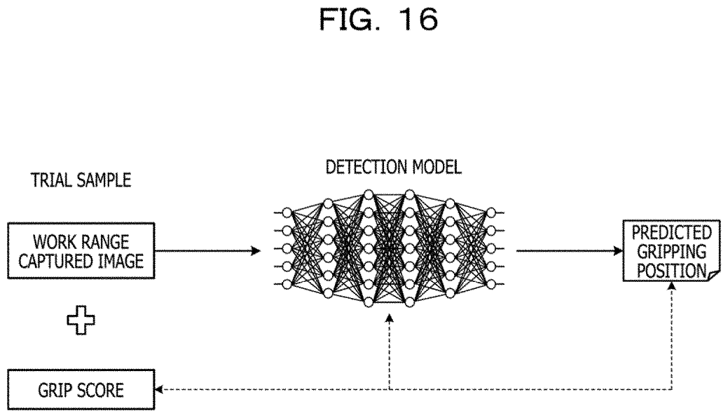

The model learning unit 24 is a processing unit that executes machine learning of the detection model by using each trial sample stored in the trial sample DB 15 after a certain number of trial samples is generated. FIG. 16 is a diagram explaining machine learning of the detection model. As illustrated in FIG. 16, the model learning unit 24 cuts out a work range captured image of a trial sample into a predetermined size, inputs each piece of data to the detection model, and selects data having the k-th highest prediction probability as an estimation result (predicted gripping position).

Then, the model learning unit 24 executes machine learning of the detection model so that the estimation result and data including a bounding box in which a teacher label showing a correct answer is set in the work range captured image match.

At this time, the model learning unit 24 executes machine learning of the detection model by increasing feedback as a grip score set in the trial sample input to the detection model increases and decreasing feedback as the grip score decreases.

Here, Single Shot Multibox Detector (SSD) is used as the detection model. Before learning is started, the weight of a synapse, which is a parameter to be learned by the SSD, is initialized to a random value. The SSD is a kind of a multilayer neural network (NN), and has following features. The SSD applies a convolutional NN which is a NN specialized for learning image data, and uses image data as input, and a plurality of detection candidates (bounding boxes and reliability (class probability) of detection objects) in the input image data as outputs. The reliability is a value indicating which class a detection object belongs to among previously set classes when the detection object is classified. In a case where it is desirable that the number of classes into which detection objects are classified is N, the number of classification classes of the SSD is N+1 including a background class. At the time of detection after learning, each detection object is classified into a class indicating a value with the highest reliability. By executing learning of a previously set default bounding box to match a bounding box showing a correct answer, the SSD enables detection with high accuracy regardless of an aspect ratio or the like of the input image data.

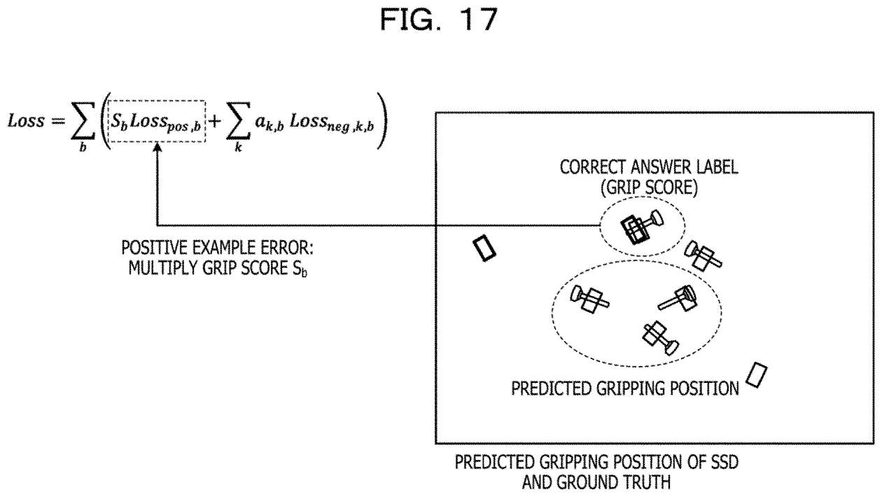

The model learning unit 24 generates the detection model by updating such parameters of the SSD by machine learning according to a grip score. FIG. 17 is a diagram explaining parameter update of the detection model. As illustrated in FIG. 17, the model learning unit 24 corrects an error on the basis of a grip score at the time of machine learning of the SSD. A grip score (S_{b}) of a trial sample is normalized such that the closer the trial sample is to an optimum gripping position, the greater the grip score. Thus, error correction according to the grip score may be implemented by multiplying the grip score by a positive example error (Loss_{pos,b}) of a loss function (L).

In this way, the model learning unit 24 executes the parameter update of the detection model so that the loss function is minimized. Note that, when learning is completed, the model learning unit 24 stores a learning result or the learned detection model in the learning result DB 16. In addition, the positive example error is an error related to a gripping position class, and a negative example error (Loss_{neg,b}) is an error related to a background class.

Returning to FIG. 3, the detection execution unit 25 is a processing unit that detects a gripping object of the picking robot by using the learned detection model. For example, the detection execution unit 25 acquires a learning result of the detection model from the learning result DB 16, and constructs the learned evaluation model. Subsequently, the detection execution unit 25 inputs image data to be determined to the detection model by a method similar to that illustrated in FIG. 7, and acquires an output result of the detection model. Then, the detection execution unit 25 acquires, as a prediction result, an output result having the highest prediction probability among output results.

In addition, the detection execution unit 25 detects a gripping position specified by the prediction result, and displays the gripping position on a display or the like or stores the gripping position in the detection result DB 17. Note that the detection execution unit 25 may also store the prediction result in the detection result DB 17.

[Learning Processing of Evaluation Model]

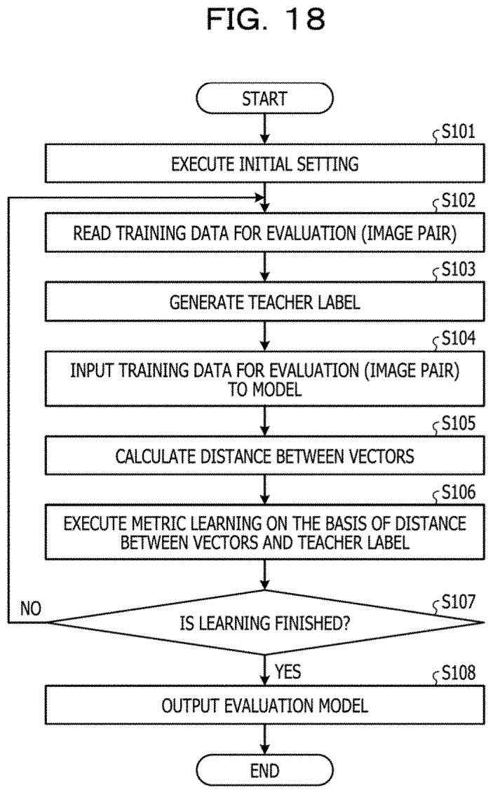

FIG. 18 is a flowchart illustrating a flow of learning processing of the evaluation model. As illustrated in FIG. 18, when start of the processing is instructed, the evaluation model learning unit 21 executes initial setting of learning parameters, a threshold, and the like (S101), reads training data for evaluation (image pair) stored in the evaluation training data DB 13 (S102), and generates a teacher label by comparing similarity between the images with the initially set threshold (S103).

Subsequently, the evaluation model learning unit 21 inputs the training data for evaluation (image pair) to the evaluation model (S104), and calculates a distance between vectors which correspond to the images and are output in response to the input (S105). Then, the evaluation model learning unit 21 executes metric learning on the basis of the distance between the vectors and the teacher label, and updates the learning parameters of the SNs applied to the evaluation model (S106).

Thereafter, in a case where machine learning is continued (S107: No), the evaluation model learning unit 21 repeats S102 and subsequent steps for the next training data. On the other hand, in a case where machine learning is finished (S107: Yes), the evaluation model learning unit 21 outputs the learned evaluation model to the storage unit 12 or the like (S108).

[Learning Processing of Detection Model]

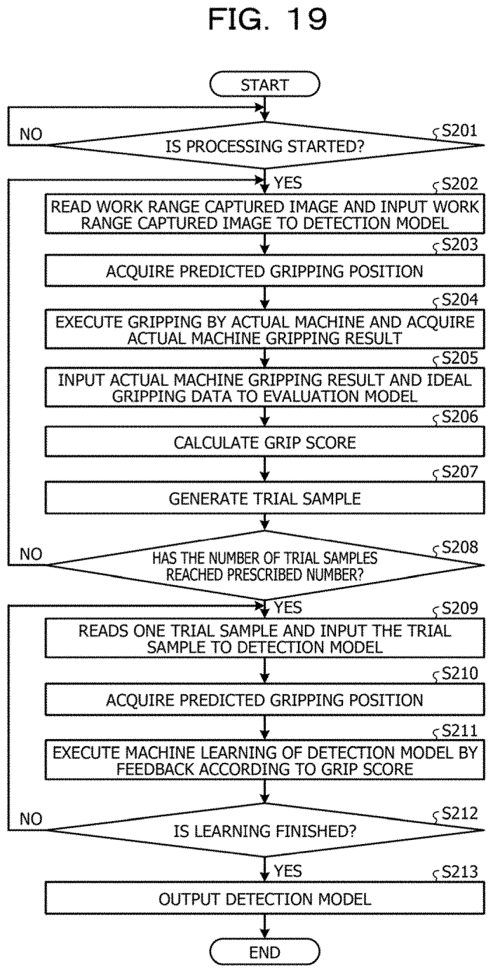

FIG. 19 is a flowchart illustrating a flow of generation processing of a trial sample and learning processing of the detection model. As illustrated in FIG. 19, when start of the processing is instructed (S201: Yes), the detection model learning unit 22 reads a work range captured image and inputs the work range captured image to the detection model (S202).

Subsequently, the detection model learning unit 22 acquires a predicted gripping position on the basis of an output of the detection model (S203), executes gripping by the actual machine with respect to the predicted gripping position, and acquires an actual machine gripping result that is image data of an actual gripping result (S204).

Then, the detection model learning unit 22 inputs ideal grip data acquired from the ideal grip data DB 14 and the actual machine gripping result by the actual machine to the learned evaluation model (S205). The detection model learning unit 22 calculates a grip score that increases as similarity increases, by using a distance between vectors that are output results of the learned evaluation model (S206).

Thereafter, the detection model learning unit 22 generates a trial sample in which the work range captured image read in S202 is associated with the grip score calculated in S206, and stores the trial sample in the trial sample DB 15 (S207). Here, the detection model learning unit 22 repeats S202 and subsequent steps for the next image until the number of trial samples reaches a prescribed number (S208: No).

On the other hand, when the number of trial samples reaches the prescribed number (S208: Yes), the detection model learning unit 22 executes machine learning of the detection model.

For example, the detection model learning unit 22 reads one trial sample from the trial sample DB 15, and inputs the trial sample to the detection model (S209). Then, the detection model learning unit 22 acquires a predicted gripping position (S210), and executes machine learning of the detection model by feedback according to the grip score so that the predicted gripping position and data including a bounding box in which a teacher label showing a correct answer is set match (S211).

Then, in a case where learning is continued (S212: No), the detection model learning unit 22 executes S209 and subsequent steps for the next image. On the other hand, in a case where learning is finished (S212: Yes), the detection model learning unit 22 outputs the learned detection model to the storage unit 12 or the like (S213).

[Effects]

As described above, the information processing apparatus 10 may reflect a distance between feature vectors of trial samples extracted by the evaluation model in machine learning by using the distance as a score of trial success or failure at the time of sequential learning. Therefore, the information processing apparatus 10 may execute machine learning in which a degree of success is rounded so that a value increases as the trial sample approaches a target trial result.

In addition, the information processing apparatus 10 may apply metric learning using similarity between trial samples as teacher data to save labelling labor for each sample acquired for each trial. Therefore, in the information processing apparatus 10, since a combination of trial samples becomes input data at the time of training, the number of training data sets may be increased as compared with normal supervised learning. In addition, the information processing apparatus 10 may train a model such that a distance between trial samples is close for the samples with the same label, and apart for the samples with different labels.

In this way, in the information processing apparatus 10, by increasing a grip score of a trial sample close to a desired sample, it is possible to increase feedback at the time of machine learning of the trial sample closer to success, and preferentially perform learning. Therefore, the information processing apparatus 10 may improve prediction accuracy.

In addition, since the information processing apparatus 10 performs machine learning on the basis of training data to which a grip score is added, it is less likely to fall into a local solution. Furthermore, in the prior art, an influence of data acquired at an initial stage of sequential learning is large. However, in the method of the first embodiment, since feedback becomes large even for data added later, an influence of data acquisition order may be reduced. Therefore, the information processing apparatus 10 may resolve instability of learning due to order in which trial samples are added to a data set, and may improve stability of machine learning (training).

In addition, the information processing apparatus 10 may omit detailed design of a threshold or the like by comparing feature values extracted by a learner from raw image data. Furthermore, since the information processing apparatus 10 may use a combination of pieces of data as training data, it is possible to create more variations even if the number of pieces of original data is the same, and to omit preparation of a large-scale data set.

### Second Embodiment

Although the embodiment has been described above, the embodiment may be implemented in various different forms in addition to the embodiment described above.

[Numerical Values or the Like]

The type of target data, the distance calculation method, the learning method applied to each model, the model configuration of the neural network, and the like used in the above embodiment are merely examples and may be optionally changed. In addition, these may be used not only for prediction of a gripping position of the picking robot, but also for determination of image data in various fields such as recognition of an unauthorized person, and sound data and the like may be applied. Furthermore, a device that executes machine learning and a device that performs detection using a model after machine learning may be implemented by separate devices.

[Trial Sample]

In addition, by using only a work range captured image when gripping is successful as a trial sample, it is possible to improve accuracy in prediction of a gripping position. Furthermore, by using only each work range captured image when gripping is successful and when gripping is failed as trial samples, the number of times of training may be increased, and it is possible to suppress falling into a local solution.

[Pre-Learning]

In the above evaluation model, learning accuracy may be improved by executing pre-learning to improve accuracy in extraction of a feature value (feature vector). In addition, since similarity between two pieces of image data (image pair) is calculated by pre-learning, it is possible to set a threshold when a teacher label is set at the time of learning of the evaluation model illustrated in FIG. 8. For example, an average value of distances of images calculated by the evaluation model may be set as the threshold, or an average value of distances between images determined by an administrator to be similar, or the like may be set as the threshold.

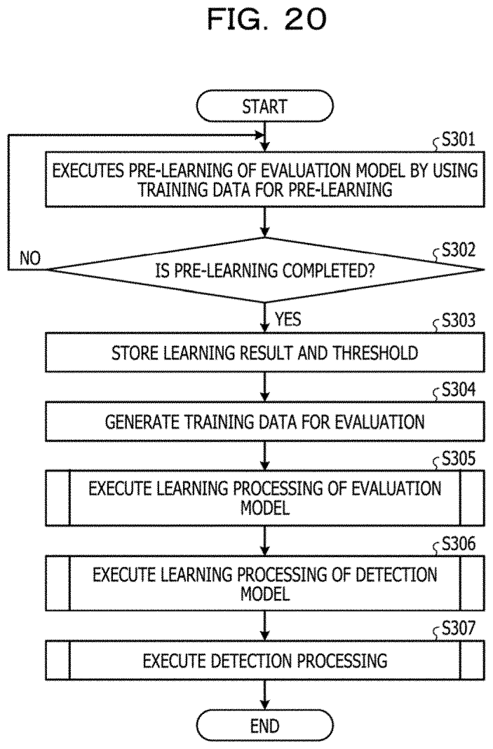

FIG. 20 is a flowchart illustrating a flow of a series of processing including pre-learning. As illustrated in FIG. 20, the information processing apparatus 10 executes pre-learning of the evaluation model by using training data for pre-learning (S301). Subsequently, in a case where pre-learning is continued (S302: No), the information processing apparatus 10 repeats S301 by using the next training data.

On the other hand, when pre-learning is completed (S302: Yes), the information processing apparatus 10 stores a learning result and a threshold in the storage unit 12 (S303). Thereafter, the information processing apparatus 10 generates training data for evaluation as in the first embodiment (S304), executes the learning processing of the evaluation model illustrated in FIG. 18 (S305), executes the learning processing of the detection model illustrated in FIG. 19 (S306), and executes detection processing using the learned detection model (S307).

[System]

Pieces of information including a processing procedure, a control procedure, a specific name, various types of data, and parameters described herein or illustrated in the drawings may be optionally changed unless otherwise specified. Note that the evaluation model is an example of a first model, and the detection model is an example of a second model. The image data in which gripping is successful is an example of image data satisfying a first condition, and the image data showing an ideal gripping state (ideal grip data) is an example of image data satisfying a second condition. The evaluation training data DB 13 is an example of a data set. In addition, the image data is not limited to two-dimensional data, and three-dimensional data may also be used.

In addition, the predicted gripping position is an example of a predicted gripping object. Furthermore, the ideal grip data is an example of a desired trial result. Note that the trial sample generation unit 23 is an example of a first calculation unit and a second calculation unit, and the model learning unit 24 is an example of an execution unit.

In addition, each component of each device illustrated in the drawings are functionally conceptual and do not necessarily have to be physically configured as illustrated in the drawings. For example, specific forms of distribution and integration of each device are not limited to those illustrated in the drawings. For example, all or a part of the devices may be configured by being functionally or physically distributed and integrated in optional units according to various types of loads, usage situations, or the like.

Furthermore, all or any part of individual processing functions performed in each device may be implemented by a central processing unit (CPU) and a program analyzed and executed by the CPU, or may be implemented as hardware by wired logic.

[Hardware]

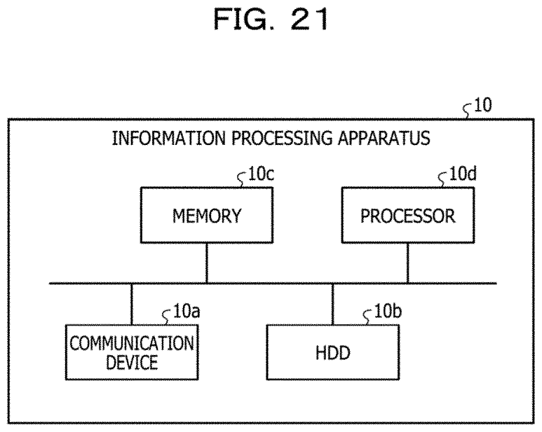

Next, a hardware configuration example of the information processing apparatus 10 will be described. FIG. 21 is a diagram explaining the hardware configuration example. As illustrated in FIG. 21, the information processing apparatus 10 includes a communication device 10a, a hard disk drive (HDD) 10b, a memory 10c, and a processor 10d. In addition, the units illustrated in FIG. 21 are mutually connected by a bus or the like.

The communication device 10a is a network interface card or the like and communicates with another server. The HDD 10b stores programs and DBs for operating the functions illustrated in FIG. 3.

The processor 10d reads a program that executes processing similar to that of each processing unit illustrated in FIG. 3 from the HDD 10b or the like to develop the read program in the memory 10c, thereby operating a process that executes each function described with reference to FIG. 3 or the like. For example, this process executes a function similar to that of each processing unit included in the information processing apparatus 10. For example, the processor 10d reads programs having functions similar to those of the evaluation model learning unit 21, the detection model learning unit 22, the detection execution unit 25, or the like from the HDD 10b or the like. Then, the processor 10d executes a process that executes processing similar to that by the evaluation model learning unit 21, the detection model learning unit 22, the detection execution unit 25, or the like.

As described above, the information processing apparatus 10 operates as an information processing apparatus that executes an information processing method by reading and executing the program. In addition, the information processing apparatus 10 may also implement functions similar to those of the above embodiments by reading the above program from a recording medium by a medium reading device and executing the read program described above. Note that the program referred to in other embodiments is not limited to being executed by the information processing apparatus 10. For example, the embodiments may be similarly applied to a case where another computer or server executes the program, or a case where such computer and server cooperatively execute the program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a program that causes a computer to execute a process, the process comprising:
identifying, among combinations of any two pieces of image data included in a plurality of pieces of image data that satisfies a first condition, similarity between two pieces of image data in a combination in which one image data satisfies a second condition in addition to the first condition;
identifying, based on the calculated similarity between the two pieces of image data, a score that becomes greater as the similarity increases; and
performing, by using training data based on another image data in the combination and the score, machine learning.

2. The non-transitory computer-readable storage medium according to claim 1, wherein
the process comprising executing processing of executing machine learning of a first model by using training data in which an image data pair is associated with a label based on similarity between the image data pair, and
the identifying the similarity includes calculating the similarity in the combination of the two pieces of image data is calculated by using the learned first model.

3. The non-transitory computer-readable storage medium according to claim 2, wherein
the process further comprising:
generating image data that satisfies the first condition by using an output result output from a second model in response to an input of image data; and
generating a data set using the image data generated by using the second model and image data that satisfies the second condition,
the identifying the similarity includes
generating the combination by using each piece of image data included in the data set, and the similarity is calculated for the combination,
the identifying the score includes
calculating the score on the basis of the similarity, and
the performing includes
performing machine learning of the second model is executed by using the training data in which the image data input to the second model is associated with the score.

4. The non-transitory computer-readable storage medium according to claim 1, wherein
the identifying the similarity includes the similarity between gripping image data as image data that satisfies the first condition and ideal gripping image data as image data that satisfies the second condition, the gripping image data showing a state where gripping operation of a picking robot is successful, the ideal gripping image data showing an ideal state of the gripping operation of the picking robot,
the identifying the score includes calculating the score on the basis of the similarity between the gripping image data and the ideal gripping image data, and
the performing includes executing the machine learning by using the training data based on the gripping image data and the score.

5. The non-transitory computer-readable storage medium according to claim 4, wherein
the process further comprising executing processing of executing machine learning of a first model by using a pair of two pieces of image data as explanatory variables and similarity between the pair of two pieces of image data as an objective variable, and
the identifying the similarity includes calculating the similarity between the gripping image data and the ideal gripping image data by using the learned first model.

6. The non-transitory computer-readable storage medium according to claim 5, wherein the process further comprising:
detecting a gripping object by using a second model that outputs a gripping object in response to an input of work image data including a plurality of gripping objects;
acquiring actual machine image data when the gripping object is gripped by using the picking robot; and
generating a data set including the actual machine image data as image data that satisfies the first condition and the ideal gripping image data as image data that satisfies the second condition.

7. The non-transitory computer-readable storage medium according to claim 6, wherein
the identifying the similarity includes:
generating a combination of the actual machine image data and the ideal gripping image data included in the data set, and
calculating the similarity for the combination,
the identifying the score includes calculating the score on the basis of the similarity, and
the performing includes executing machine learning of the second model by using the training data in which the work image data input to the second model to acquire the actual machine image data is associated with the score.

8. The non-transitory computer-readable storage medium according to claim 7, wherein the performing includes
executing the machine learning such that feedback for updating a parameter of the second model is increased as the score becomes greater at a time of the machine learning of the second model.

9. A learning method executed by a computer, the learning method comprising:
identifying, among combinations of any two pieces of image data included in a plurality of pieces of image data that satisfies a first condition, similarity between two pieces of image data in a combination in which one image data satisfies a second condition in addition to the first condition;
identifying, based on the calculated similarity between the two pieces of image data, a score that becomes greater as the similarity increases; and
performing, by using training data based on another image data in the combination and the score, machine learning.

10. An information processing apparatus, comprising:
a memory; and
a processor coupled to the memory and configured to:
identify, among combinations of any two pieces of image data included in a plurality of pieces of image data that satisfies a first condition, similarity between two pieces of image data in a combination in which one image data satisfies a second condition in addition to the first condition,
identify, based on the calculated similarity between the two pieces of image data, a score that becomes greater as the similarity increases, and
perform, by using training data based on another image data in the combination and the score, machine learning.
